(19) United States
(12) Patent Application Publication
(10) Pub. No.: US 2008/0133283 A1
(43) Pub. Date: Jun. 5, 2008

(54) WIRELESS REMOTE QUEUING SYSTEM AND METHOD

(76) Inventors: Alejandro Backer, Altadena, CA (US); Timothy Ross McCune, Santa Monica, CA (US)

Correspondence Address: LADAS & PARRY, 5670 WILSHIRE BOULEVARD, SUITE 2100, LOS ANGELES, CA, 90036-5679, US

(21) Appl. No.: 11/941,849

(22) Filed: Nov. 16, 2007

Related U.S. Application Data
(60) Provisional application No. 60/893,644, filed on Mar. 8, 2007.

(51) Int. Cl. G06Q 10/00

(52) U.S. Cl. 705/5

(57) ABSTRACT

The disclosure describes methods and systems of allowing people to virtually queue in a line via text messaging or mobile phone calls. The person wishing to get in the line sends a text message or cell phone call to a queuing system. Alternatively, the person can register via a computer network connection. The queuing system then sends a text message back to that person when it is nearly time for them to receive the benefit of being at the front of the line.

### CROSS-REFERENCES TO RELATED APPLICATIONS

This application claims benefit to U.S. provisional application 60/893,644 filed on Mar. 8, 2007, for “Various” by Alejandro Backer, the disclosure of which is incorporated herein by reference.

### FIELD

The present disclosure is directed to facilitating the process of having people wait in line for an event or service. More in particular, this disclosure is directed to methods and systems of using existing cell phone technology to allow people to enter a virtual queue and receive notification via text messaging when they are near the front of the virtual queue.

### BACKGROUND

Every day, millions of people waste their precious time standing in line. Queues (or “lines”) are an old and outdated system to apportion goods or services in limited supply to demand that is at times larger than supply. Why do queues work at all? Why don't they grow forever? They exploit two principles: first, they smooth demand across time, by moving it from peak times to other times. Second, they create a negative feedback loop, reducing demand during peak times by raising the cost (in wait time) of service in proportion to current demand, making it increasingly unattractive for customers to join the queue as it grows longer. But queues which force customers to stand in line suffer from multiple problems. First, they waste people's time which could be better spent. Second, they discourage transfer of demand from a long queue to a shorter one, by failing to provide information on the length of other queues.

U.S. Pat. No. 6,529,786 to Sim (hereafter “Sim”) describes a queue management system which comprises a plurality of portable modules, at least one docking station, a queue manager, signal transmitting means, at least one module detector and a communication means. Each portable module includes a memory means containing a unique identification code, an indicator means, transmitter means for transmitting the identification code over a short range, and docking means for downloading the identification code. The docking station registers the person in a queue by downloading the identification code for the portable module when docked. The queue manager maintains the queue sequence for each queue and includes a communication means for receiving the downloaded code. The signal transmitting means is associated with the queue manager for transmitting the signals to each portable module to instruct the person carrying the portable module to join the queue. The module detector detects transmitted identification codes from any portable module in its vicinity. The module detector is arranged at the queue to detect when the person carrying the portable module joins the queue. Finally, the communication means is arranged between the queue manager and the module detector to communicate any detected identification code to the queue manager. However, the system and method of Sim appears to require that the people wanting to join the queue be given special portable modules that are specially constructed for use with Sim's invention.

U.S. Pat. No. 6,748,364 to Waytena et al. (hereafter “Waytena”) describes a system and method for assigning and managing patron reservations to one or more of a plurality of attractions receive reservation requests at personal communication devices (PCDs). Reservation requests are transmitted to a computer associated with the selected attraction, which determines a proposed reservation time based on information describing the attraction, the patron, previously-made reservations maintained in a virtual queue, and the current state of a physical queue associated with the attraction. Proposed reservation time is transmitted to the PCD for confirmation or rejection by the patron. Confirmed reservations are entered in the virtual queue. Patrons are alerted by the PCD when their reservation time is approaching. Like Sim above, the system of Waytena appears to require the people wishing to join the queue to possess specially adapted personal communication devices.

U.S. Pat. No. 6,845,361 to Dowling (hereafter “Dowling”) describes a method and a system are provided for maintaining a virtual-wait queue that controls access by customers to a physical resource such as a restaurant table. The method and system are especially adapted for use by customers operating Internet-enabled wireless devices. The system operates by maintaining a virtual-wait queue data structure capable of storing a plurality of entries. Each entry is representative of a customer. The system accepts an instruction from a premises I/O device indicating to either add or delete an entry to the data structure. The system also accepts an instruction from a network connection to either add or delete the remote customer into or from the virtual wait queue. The virtual wait queue system indicates to the remote customer the estimated time left in the queue, freeing the customer from the need to wait in line. While the wireless devices of Dowling do not have to be specially adapted (as they were in Sim or Waytena), they do appear to need to be Internet-enabled, which is not yet a ubiquitous feature for cell phones.

U.S. Pat. No. 6,889,098 to Laval (hereafter “Laval”) describes a method and system for managing admission to an attraction. In one or more embodiments, the system comprises a first queue by which customers may access the attraction by waiting in line and a second queue by which customers may access the attraction in a manner which avoids the first queue. The system includes a first validator for validating an entitlement of a customer to receive an assigned time in the future for accessing the attraction via the second queue, a media distributor for distributing a media to an entitled customer, the media including the assigned time at which the entitled customer is entitled to access the attraction in the future, and a second validator for validating the entitled customer access to the attraction at the time provided on the media. In accordance with a method of the invention, a customer may access an attraction in a manner which avoids standing in a first waiting line by verifying entitlement to utilize a second queue, obtaining a pass entitling the customer to access the attraction at a future time, and returning to the attraction at the future time and gaining access with the pass. In this method, the customer may leave the vicinity of the attraction between when the pass is issued and the future time at which the customer is entitled to access to the attraction. However, the method and system of Laval appears to require the distribution of physical passes with a then-determined access time.

U.S. Pat. No. 7,047,205 to Hale et al. (hereafter “Hale”) describes a method and system for the loading of patrons at multiple attractions at an entertainment includes the first-in first-out line and a priority based line. A cellular telephone is used to obtain and claim priority status. In other forms different priorities are established based on where, when and the number of priority spaces required. Different hierarchies are established for computer controlling the different lines for multiple attractions in the entertainment environment. The system and method also provide for moving people from an area of concentration to other locations. Like Laval, the Hale system and method appears to determine the time of event access at the point at which the patron requests entry into the queue. If the queue rate changes after that point, the patron's entry time is not changed unless they re-enter the queue.

### SUMMARY

The present disclosure addresses the problems involved with long queues. One object of the disclosed method and system is to allow people to enter a long queue for an event without having to physically stand in a line for a long time. The system allows people to access the queue via a common cell phone or similar device with SMS text messaging capability, a common feature for cell phones today, or a similar messaging system, such as instant messaging or text messaging via a phone widget (software application for a cell phone)—collectively referred to in this disclosure as simply “text messaging”. The queue can also be entered via a computer interface, such as a web site interface, a computerized touch-screen kiosk user interface, or a computer interface run by an attendant. Once accessed, the person is set in a virtual queue—a queue that is established in a database and that tracks the movement of the actual queue. When the person reaches a particular placement or estimated time remaining in the virtual queue, the system notifies the person via text messaging to return to the actual queue for entry to the event.

The queue management system can be composed of one or more of the following:
1) Each queue is assigned a queue or event number, which can be displayed prominently at the location as well as other places, together with a telephone number to call to enter a queue (e.g. a 1-800 number).
2) A person who wishes to enter the queue (“stand in line”) can send a Short Message Service text message to the corresponding telephone number. The text message contains the event number (in the case of a phone call, the event number is dialed in using a touchtone phone). Caller ID (identification of the person's cell phone number sent with the call) can be used to ascertain the caller's phone number automatically. Alternatively, the phone number can be included in the text message, such as placing the number in the “From” field or separating the phone number from the event number by using the Subject for one and the text for the other. Events may choose to rent out cell phones to people who do not have one. Alternatively, the person can request entry into the queue via a web page or kiosk interface, typing in their cell phone number that will receive notification later. Alternatively, the person could enter the queue over the phone via a voice recognition system. Alternatively, the person could text message via instant messaging or some other multimedia messaging system.
3) The system places requests in the queue in the order received.
4) The system knows the carrying capacity of the event and the current status of the queue. For example:
   a) The event owners pre-set the capacity information into the system.
   b) The event uses a device that transmits to the system every time a space becomes available (i.e. that monitors the movement of the actual queue). For instance, a turnstile connected to a device that sends a signal to the system every time a person goes by can be used to allow the queuing system to count the number of people entering and/or exiting an event or location. Other possible devices include motion sensors, intelligent vision systems, and pressure plates. Alternatively, an event employee could transmit the information via a push-button system or the like.
   c) The event owner can notify the system that a number of spaces have become available by sending a text message or phone call with a code that identifies him/her as the owner of the event, and the number of spaces that have become available.
   d) Alternatively, the system could allow entrance automatically at a pre-determined rate.
   e) Issuing tickets for the event could be perform contemporaneously with allowing entrance, or could be occur when the people enter the queue.
5) This information is used by the system to allocate spaces on a first-come first-served basis.
6) N minutes before a space becomes available for a given person, that person is notified via a text message (alternatively, via a phone call). N can be preset by the event owner, or set by default, or set by the user via a text message (e.g. with a line in the text message that specifies N minutes). In some embodiments, multiple notifications may be sent at different intervals before the estimated availability of space.
7) The person in the queue attends the event. Verification that it is his/her turn can be done in a variety of ways, for example:
   a) By showing the recent text message from the system.
   b) By having the system send a text message that provides a code that can be presented at the queue.
   c) By presenting the phone number used to enter the queue, previously entered into the system either by caller ID or manual entry.
8) Additional enhancements:
   a) Scheduler for a theme park or other set of events such that a user can list all the attractions they want to go to, optionally with information on priority of each, and the scheduler computes an optimal schedule for them, then informs them of where to go at each time through a text message or automated phone call.
   b) If a user gets delayed during the day and notifies the system, the scheduler can automatically adjust the schedule for the remainder of the day.
   c) Providing a web page (virtual) or computer kiosk (physical) user interface that allows people to enter themselves in the queue.
   d) A feature whereby people can leave the queue via their cell phone. For example, sending the text message “leave” to the system could remove the sender from the queue.
   e) A feature whereby people can request more time if they are not prepared to return to the event. For example, sending the text message “wait” to the system could move a person back in the queue by either an amount of time or a number of places. Additionally, the feature could allow the sender to determine how far back they are placed. For example, sending the text message “wait 5” to the system could move that person back 5 minutes (estimated) in the queue.
   f) The virtual queue can be integrated with an actual queue, where preference is given to the person who is in the virtual queue and is scheduled to enter at that time.
   g) A further embodiment includes the ability for people to buy and sell positions in the virtual queue. For example, a person can indicate in the text message that they are willing to sell their position in the queue. The queue system displays, for example at a kiosk or web page, the available queue positions and their prices. The prices can be automatically generated by the system based on popularity of the event and the position's estimated time to entrance, or the price can be set by the person selling the position. Another person can then purchase the position via an e-commerce transaction and enter their own cell phone number or text messaging address to take their place in the queue.
   h) The advantages of maintaining a virtual queue include the ability to generate reports on data such as customer return rates (tracked by phone numbers), average wait time, maximum wait time, number of entries into the queue at various times/days, and the like.
   i) The system could include advertising in the text messages. A more sophisticated system could target the advertising based on the location of the event and past queues the person has joined.
   j) Several queue systems could be connected into one large system that co-ordinates all of the queues. This allows the customer to, instead of selecting a queue, select a set of criteria for the type of queue he wants to enter. The system then places the person in all of the virtual queues that match the criteria and notifies him of the first available event. For example, a user could request “any five star restaurant in the 90210 zip code area.” The system would place the person in all of the queues for all of the five star restaurants in the 90210 zip code area, then notify the user when they are close to being at the front of a queue and which restaurant the user should go to.

The applications for this system and method are numerous. For example, the system could be used to manage the queues found at banks, amusement parks, security checkpoints, airport/bus/train terminals, pharmacies, retail stores, customer service desks, auto repair shops, hair salons, etc. Any situation that requires people waiting for service could benefit.

Also, the system could be modified to automatically integrate reservations into the system with people standing in a physical queue. For example, a person sends a message to join a virtual queue at 7:50 PM with a 15 minute wait. Normally, this would allow the person to enter at 8:05 PM. But if someone else has a conventional reservation at 8 PM, they would have priority over the person in the virtual queue.

According to a first aspect of the disclosure, a method for queuing an event or service is disclosed, comprising the acts (steps) of: establishing a virtual queue on a computer system that corresponds to an actual queue; receiving data from a person who wants to enter the actual queue; automatically adding the person to the virtual queue, wherein the person is given a position in the virtual queue; advancing the virtual queue as the actual queue advances; and notifying the person by a text message when they reach a specified position in the virtual queue

According to a second aspect of the disclosure, a system for managing a queue for an event or service is disclosed, comprising: a computer server adapted to be a queue system; a database accessible by the queue system; and one or more cell receivers driven by the queue system and accessible by a cellular network, wherein the one or more cell receivers are capable of sending and/or receiving text messages.

### DESCRIPTION OF THE DRAWINGS

FIG. 1 depicts a customer using a cell phone to send a text message to the queue system.

FIG. 2 depicts the queue system placing the customer's identification in a queue for the requested event.

FIG. 3 depicts the queue system generating estimated time remaining in the queue for each customer.

FIG. 4 depicts the queue system sending a text message to the customer's cell phone when the estimated time remaining in the queue for that customer reaches a pre-set time, in this case 5 minutes.

FIG. 5 depicts how the queue system would handle queue access from a phone that does not support text messaging.

FIG. 6 depicts how a system manager would be able to update the status of a queue using text messaging.

FIG. 7 depicts a feature-rich system.

FIG. 8 depicts a system diagram of an embodiment of the system.

### DETAILED DESCRIPTION

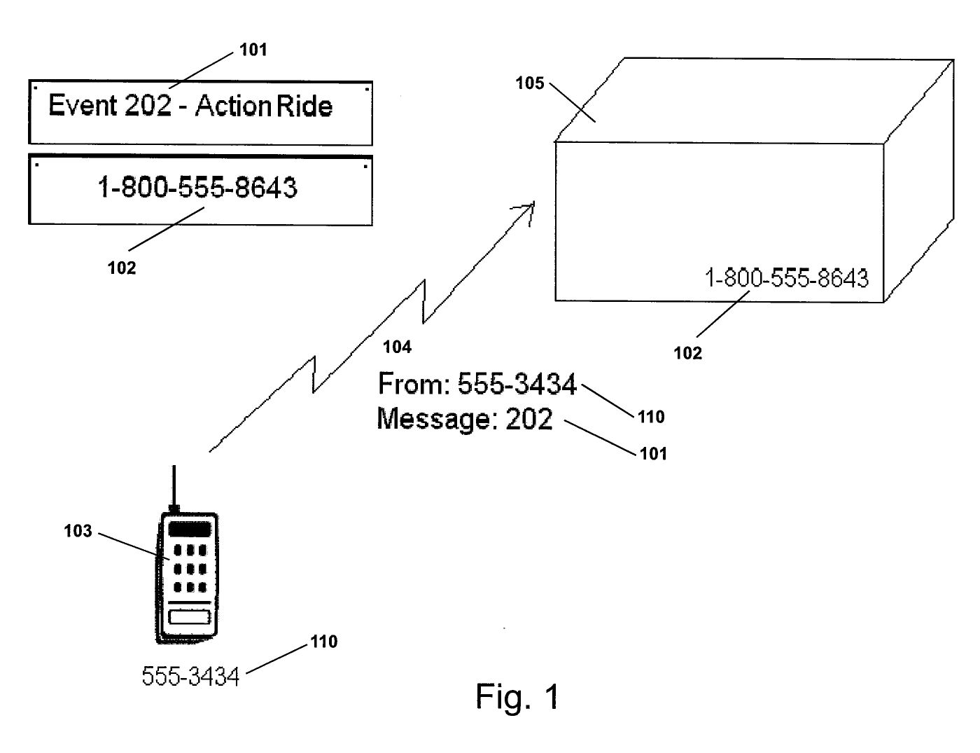

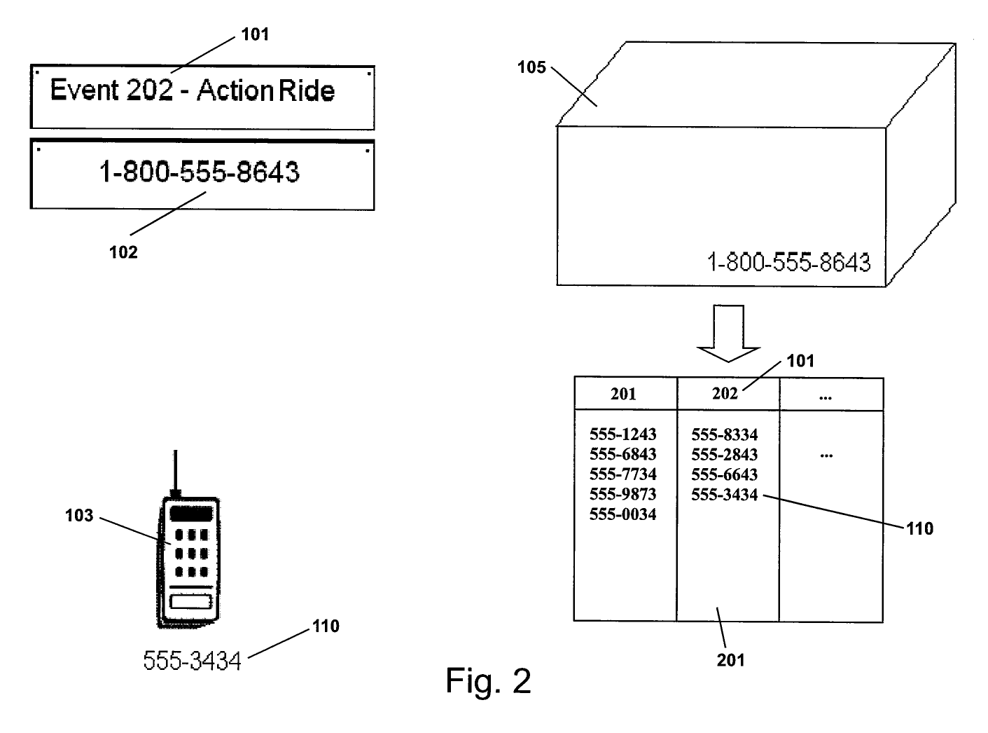

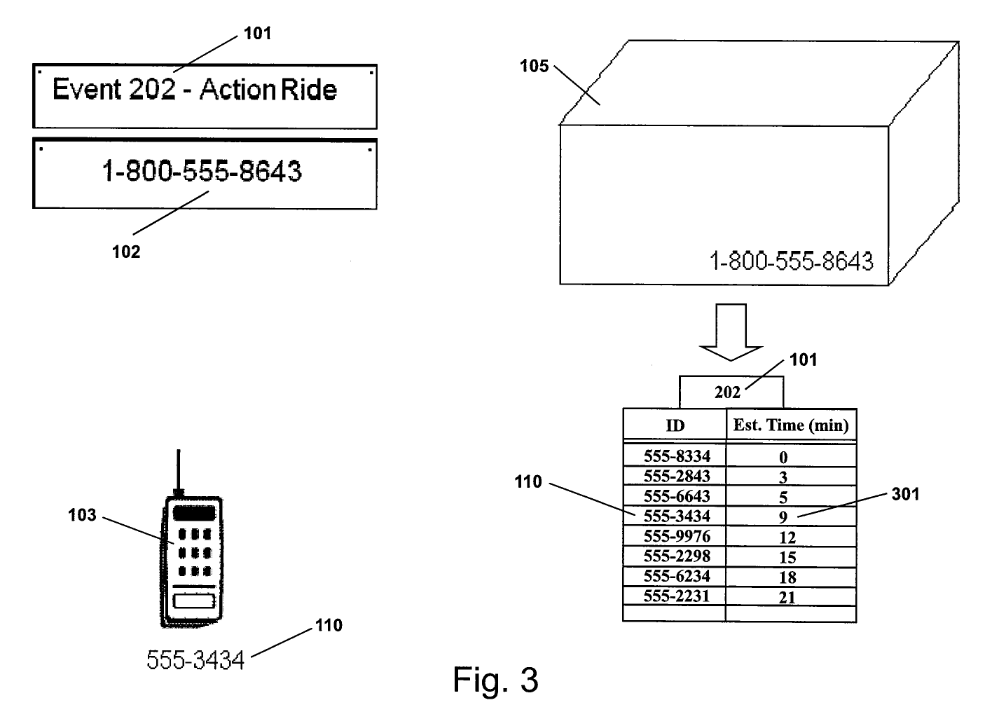

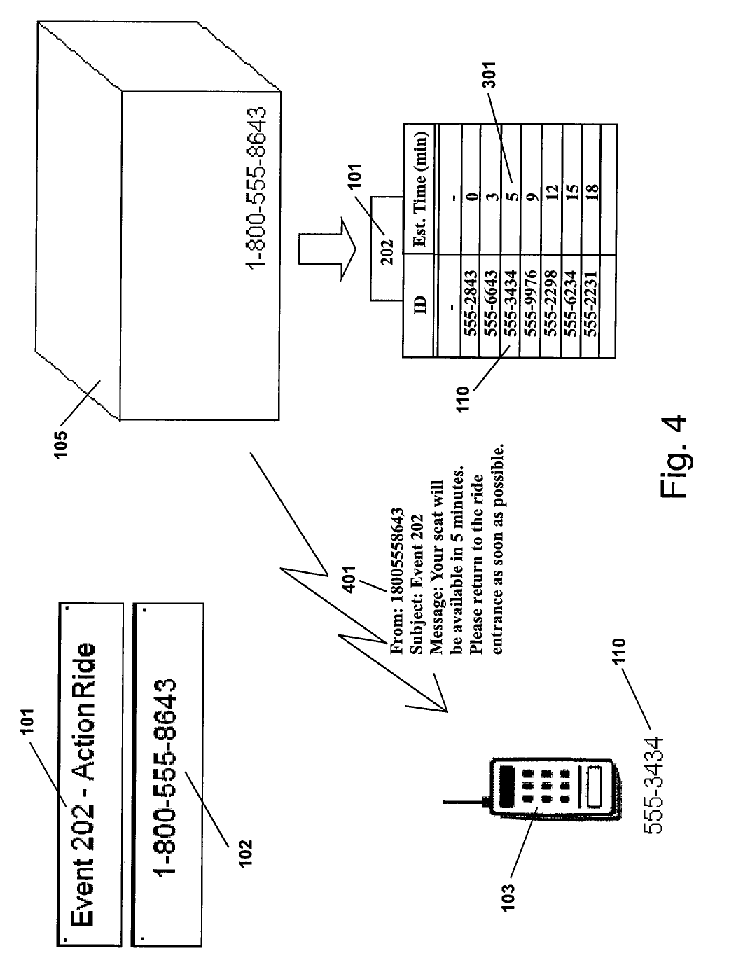

The following is an example of the queue system in operation. FIGS. 1-4 show an example of the operation step by step. First, a customer attends an event that displays and event number 101 and a phone number 102. The customer uses a cell phone 103 or some similar mobile telephonic device to send a text message 104 to the queue system 105. The message may contain the customer identification number of the user 110 (in this case, the phone number of the cell phone used) and the event number 101 the user wishes to queue for. The queue system 105 can be a computer capable of receiving text messages as input and sending text messages as output. Then, the queue system 105 stores a list 201 of customer identification numbers, such as their cell phone numbers, for each event identifier 101. The list 201 is typically ordered first-come, first-served, but the order can be changed to meet the requirements of the people scheduling the event. The list forms the virtual queue. The queue system 105 then estimates the time remaining in the virtual queue for each customer identification number 110. When the estimated time remaining 301 in the queue reaches a pre-designated number, such as 5 minutes, the queue system 105 sends a notification, typically a text message 401, to the customer's cell phone 103 alerting them to prepare to attend the event. The person is then allowed to attend the event by way of a special entrance established for people who waited in the virtual queue.

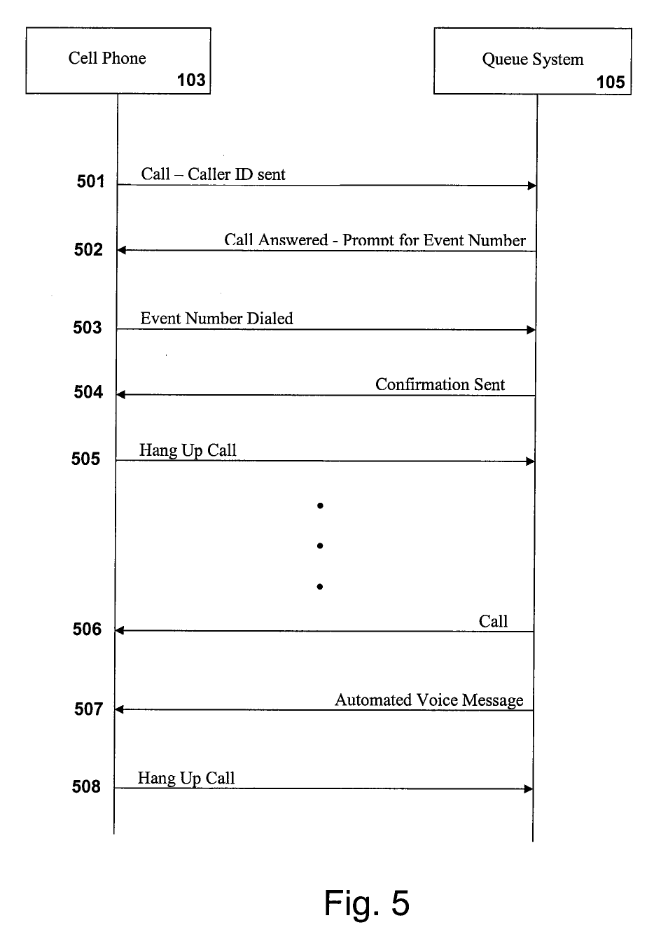

FIG. 5 shows one way in which the system could interact with cell phones that do not support text messaging. The cell phone 103 calls 501 the queue system 105. The cell phone 103 is identified to the queue system 501 by the Caller ID information contained in the call 501. The queue system 105 sends a pre-recorded voice message 502 to prompt for the input of the event number. The event number is then keyed in 503 by the cell phone 103. The queue system 105 then confirms 504 that the event number has been keyed in 503 and the cell phone 103 can now disconnect the call 505. The queue system 105 processes the queue and when the cell phone 103 user is at a point in the queue when the user should begin to prepare for the event, the queue system 105 calls 506 the cell phone 103 using the Caller ID number previously received 501. The queue system 105 sends an automated voice message 507 notifying the cell phone 103 user how much longer they have in the queue. The user can then disconnect the call 508 and proceed to the event.

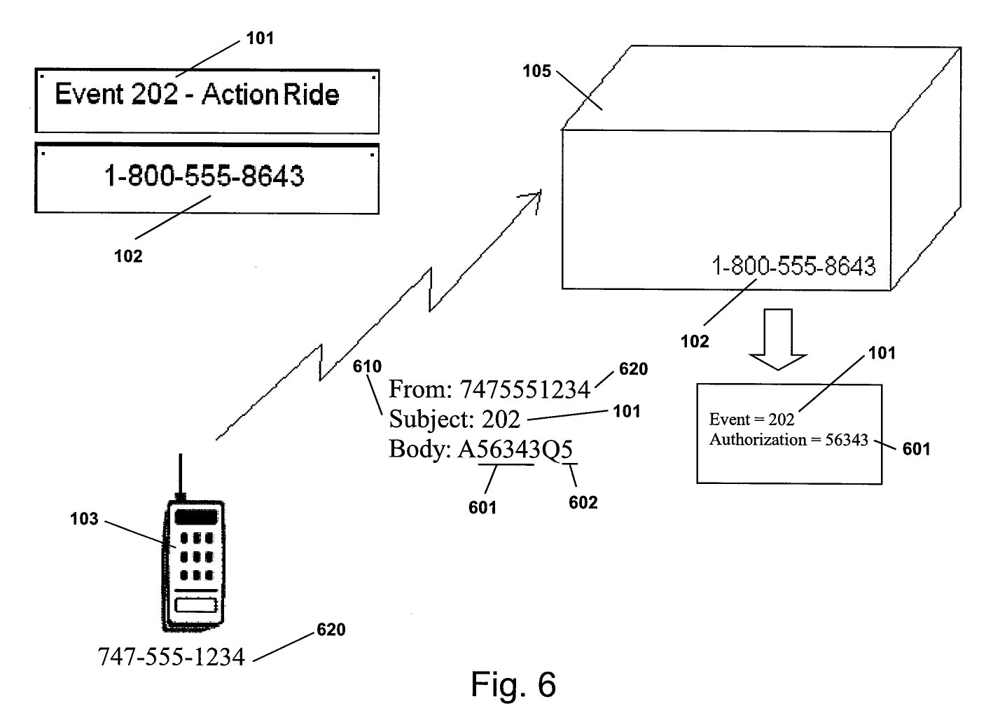

FIG. 6 shows how an event manager's telephonic device 103 (which does not need to be specialized hardware . . . an off-the-shelf cell phone can be used) can be used to update the queue being processed by the queue system 105. The event manager (or any person with the authority to update the queue status) sends a text message 610 to the queue system 105. The message 610 contains at least three pieces of information. One, the message identifies the queue identifier 101 of the queue to be modified. Two, the message contains an authorization code 601 that identifies the sender of the message as having the right to modify the queue. Three, the message indicates what quantity of resources have become available for the queue 602, so the queue system 105 can advance the queue. Additionally, the message could contain the identification number 620 of the manager making the request, typically in the form of the sender's phone number. This could be used to either add an additional level of security to the system by only authorizing update messages from certain identification numbers, and/or allowing the system 105 to call the event manager's device 103 to provide feedback information on the queue.

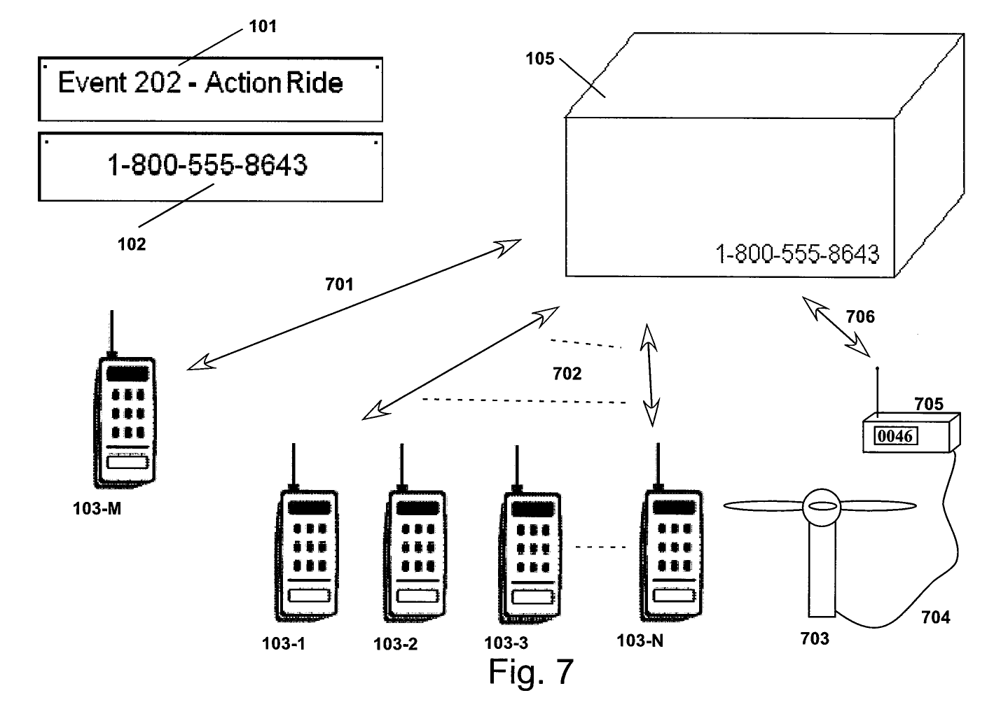

In FIG. 7, we see the system as a whole. A notice is displayed that indicates the event identifier 101 and phone number 102 for a given queue. A queue system 105 manages the queue by creating a virtual queue. People with cell phones or text messaging devices 103-1 to 103-N who wish to enter the queue send calls or text messages 702 to the queue system 105. The queue system 105 enters the people into the virtual queue and advances said virtual queue by receiving event capacity updates via text messages 701 from a management cell phone 103-M and/or update messages 706 from an automatic counter 705 connected 704 to a device 703, such as a turnstile, that counts people entering the event. As the queue advances, the queue system 105 notifies the people 103-1 to 103-N in the queue via automated calls or text messages 702 that they are near the front of the queue.

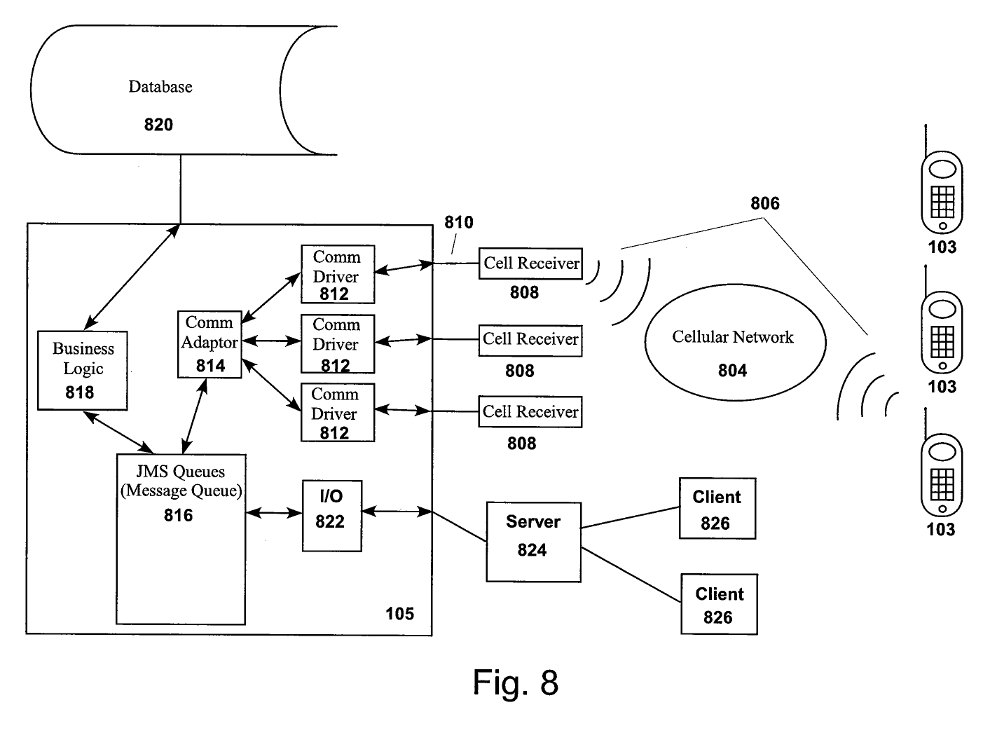

FIG. 8 depicts a system diagram of an embodiment of the queue management system. The queue system 105 can consist of one or more communications drivers 812 programmed or adapted to drive an array of cell receivers 808. The cell receivers 808 can be actual cell phones adapted for use with the queue system 105. Commercial SMS gateways can also take the place of the cell receiver/transmitters 808, but are currently a more expensive option. Some cell receivers 808 can also perform as cell transmitters, while other cell receivers 808 can be dedicated receivers, depending on the expected communications traffic pattern. The communications drivers (“Comm Drivers”) 812 are controlled by a communications adapter 814 that interfaces the Comm Drivers 812 with the rest of the queue system 105. The incoming messages are managed by a software queue 816 (not be confused with the virtual queue—this is a queue of messages to the system, not of people), such as Java Message Service (“JMS”). The business logic 818 reads off the messages from the software queue 816 and adjusts the virtual queue accordingly. The virtual queue itself is maintained in a database 820 which can be internal or external to the queue system 105. The business logic 818 also monitors the database 820 to determine if the system 105 needs to send a message via the cellular network 804 to the cell phone 103 of a customer or administrator. Alternatively, the registration into the queue can be performed by a remote client machine 826, such as an touch-screen kiosk or registration terminal, connected to a remote server 824. Likewise, the remote client machine 826 can be adapted to advance the queue or otherwise manage the queue. The remote server then connects to the queue system 105. The connection can be a standard I/O interface 822 and can provide messages to the JMS Queues 816 for processing by the business logic unit 818.

While various embodiments of the present disclosure have been described above, it should be understood that they have been presented by way of example, and not limitation. It will be apparent to persons skilled in the relevant art or arts that various changes in form and detail can be made therein without departing from the scope of the invention. Thus, the present claimed invention should not be limited by any of the above-described embodiments, but should be defined only in accordance with the following claims and their equivalents.

1. A method for queuing an event or service, comprising:
establishing a virtual queue on a computer system that corresponds to an actual queue;
receiving electronic data from a person who wants to enter the actual queue;
automatically adding the person to the virtual queue, wherein the person is given a position in the virtual queue;
advancing the virtual queue as the actual queue advances; and
notifying the person with a text message when the person reaches a specified position in the virtual queue.

2. The method of claim 1, further comprising:
displaying a queue identifier for the actual queue;
displaying a queue access number in relation to the queue identifier; and
estimating how much estimated time each queue identifier has before reaching the front of the virtual queue;
wherein
the receiving of data includes receiving a text messaging device telephone number;
the adding the person to the virtual queue includes placing the text messaging device telephone number in the virtual queue;
the virtual queue is stored as data on a computer;
the advancing of the virtual queue is performed by advancing the text messaging device telephone number in the virtual queue; and
the specified position is determined by the estimated time.

3. The method according to claim 1, wherein the receiving of data includes receiving data from the person entering the data into a computer.

4. The method according to claim 1, wherein the text message is comprised of a queue identifier, an availability metric, and an authorization code.

5. The method according to claim 1, wherein advancing the virtual queue includes automatically measuring event attendance.

6. The method according to claim 1, wherein the text messaging is Short Message Service (SMS) text messaging.

7. The method according to claim 1, wherein the text messaging is instant messaging.

8. The method according to claim 2, wherein the queue identifier includes an alphanumeric code within the text message.

9. The method according to claim 2, wherein the queue identifier includes a caller identification data (ID) provided with the text message.

10. The method according to claim 1, wherein a purchaser can purchase a position in the virtual queue from the person.

11. The method of claim 1, wherein the advancing of the virtual queue includes receiving a signal by a device that monitors the advancement of the actual queue.

12. A system for managing a queue for an event or service, comprising:
a computer server adapted to be a queue system;
a database accessible by the queue system; and
one or more cell receivers driven by the queue system and accessible by a cellular network, wherein the one or more cell receivers are capable of sending and/or receiving text messages.

13. The system of claim 12 wherein the queue system is comprised of:
one or more communications drivers for driving the one or more cell receivers;
a communications adapter for controlling the one or more communications drivers;
a software messaging queue for managing messages received by the one or more cell receivers; and
a business logic unit adapted for managing a virtual queue.

14. The system of claim 12 wherein the database is integrated into the queue system.

15. The system of claim 12 wherein the one or more cell receivers includes a Short Message Service (SMS) gateway device.

16. The system of claim 13, further comprising a device for measuring the movement of an actual queue which is connected with the business logic unit to give the business logic unit input as to how to advance the virtual queue.

17. The system of claim 16, wherein the device is a turnstile adapted to send a signal to the business logic unit whenever someone goes through the turnstile.

18. The system of claim 12, wherein the one or more cell receivers includes cell phones adapted for use with the queue system.

19. The system of claim 13, further comprising one or more computers connected to the queue system, each of the one or more computer containing software adapted to provide data to the business logic unit regarding the virtual queue.

20. The system of claim 19, wherein the one or more computers are remote servers connected to clients via a network, wherein the data is entered into the clients and transmitted to the remote servers.
